(19) United States
(12) Patent Application Publication
(10) Pub. No.: US 2019/0077466 A1
(43) Pub. Date: Mar. 14, 2019

(54) ALUMINUM STRUCTURAL MEMBER

(71) Applicant: Kabushiki Kaisha Kobe Seiko Sho (Kobe Steel, Ltd.), Kobe-shi (JP)

(72) Inventors: Yoshihaya IMAMURA, Fujisawa-shi (JP); Chieko IMAI, Fujisawa-shi (JP)

(73) Assignee: Kabushiki Kaisha Kobe Seiko Sho (Kobe Steel, Ltd.), Kobe-shi (JP)

(21) Appl. No.: 15/765,665

(22) PCT Filed: Oct. 14, 2016
(86) PCT No.: PCT/JP2016/080627

§ 371 Date: Apr. 3, 2018

(30) Foreign Application Priority Data
Oct. 19, 2015 (JP) 2015-205847
Jul. 25, 2016 (JP) 2016-145389

(51) Int. Cl. B62D 29/00; B22D 19/04

(52) U.S. Cl. CPC B62D 29/008; B62D 25/08; B22D 19/04

(57) ABSTRACT

The aluminum structure member according to the present invention is provided with an aluminum wrought material comprising aluminum or aluminum alloy, and an aluminum alloy casting joined in a state in which the aluminum wrought material is inserted therein. The aluminum wrought material has a joining part in which a portion protrudes to the outside from the aluminum alloy casting.

### TECHNICAL FIELD

The present invention relates to an aluminum structural member.

### BACKGROUND ART

Many of structural materials for automobiles are wrought materials such as steel materials and aluminum materials (pipes and plate-pressed parts). Some of these structural members such as instrument-panel reinforcements each include a portion (a shape-changing portion) where the shape of the member changes from a large-diameter portion to a small-diameter portion. To form a member including such a shape-changing portion from a wrought material, a technique of connecting cylindrical members having different diameters to each other with a connector (PTL 1) or a technique of fastening a pipe member by causing an end of the pipe member to overlap a pipe material having a smaller diameter and then reducing the diameter at the end of the pipe member (PTL 2) is employed. There is another proposal for a technique in which a shape-changing portion is formed as a casting and is joined to a pipe member with adhesive or by welding (PTL 3). There is yet another proposal for a cast structure that is obtained by inserting an end of a hollow member formed from an aluminum-alloy extrusion into aluminum alloy so as to form an integral body (PTL 4).

### CITATION LIST

### Patent Literature

PTL 1: Japanese Unexamined Patent Application Publication No. 2001-253368

PTL 2: Japanese Unexamined Patent Application Publication No. 2005-306083

PTL 3: Japanese Unexamined Patent Application Publication No. 2008-127010

PTL 4: Japanese Unexamined Patent Application Publication No. 2004-344955

### SUMMARY OF INVENTION

### Technical Problem

To make such a shape-changing portion only from a wrought material, a plurality of working steps need to be performed before the material comes to have a predetermined shape, which may lead to low productivity. Moreover, there is a problem in that since the shape into which the wrought material can be formed by plastic working is limited, the design flexibility in the shape of the member is low.

To partially reinforce the structural material while suppressing the weight increase, a reinforcing member may be added to the shape-changing portion. Such a reinforcing member also needs to be formed into a shape conforming to the shape-changing portion at the position where the shape of the structural material changes. Hence, there is a problem in that it is difficult to make the reinforcing member, and it is also difficult to accurately place the reinforcing member at a predetermined position.

On the other hand, a cast member can be formed into a predetermined shape, even into a complicated shape, by one casting step, which leads to high productivity. However, to join the cast member to another member, an attaching surface for realizing accurate attaching needs to be formed. In such a case, a cutting process is essential, which makes it difficult to improve productivity. Moreover, it is difficult to form a thin portion in the cast member and to make a large cast member. Therefore, to make a large member, a cast member and a wrought material may be joined. The cast member and the wrought material cannot be welded to each other because of the presence of pores (cavities) in the casting and therefore need to be joined with adhesive or with mechanical fastening means such as bolts.

If the two are joined with adhesive, it is difficult to provide a predetermined strength at the junction and, particularly, there is a problem in that the joining strength is reduced with aging. In addition, the two need to be set on a jig for retaining them at the respective positions for attaching during a period after the adhesive is applied until the resin contained in the adhesive is cured. Therefore, the workability is lowered. On the other hand, if the two are joined with mechanical fastening means, there is a problem in that the total weight of the structure increases and the manufacturing process becomes troublesome.

The structure disclosed by PTL 4 includes flow-blocking means at an end thereof so that molten aluminum is prevented from flowing into the end thereof. The molten metal does not flow (run) well around the flow-blocking means. Therefore, a gap where the hollow member and the cast member are not in close contact with each other may be produced at the junction.

The present invention has been conceived in view of the above circumstances, and an object of the present invention is to provide an aluminum structural member having high design flexibility in the shape of the member and providing excellent workability.

### Solution to Problem

The present invention provides the following.

An aluminum structural member including: an aluminum wrought material made of aluminum or aluminum alloy, and an aluminum-alloy casting joined to the aluminum wrought material while being wrapped around the aluminum wrought material,

wherein the aluminum wrought material includes a joining portion protruding to an outside from the aluminum-alloy casting.

### Advantageous Effects of Invention

The aluminum structural member according to the present invention provides increased design flexibility in the shape of the member whose shape changes significantly, for example, from a large-diameter portion to a small-diameter portion in the long-side direction, and also provides increased workability.

### BRIEF DESCRIPTION OF DRAWINGS

FIG. 1A is a diagram for describing an embodiment of the present invention and is a perspective view of an aluminum structural member according to a first exemplary configuration.

FIG. 1B is a plan view of FIG. 1A.

FIG. 1C is a sectional diagram taken along line I-I illustrated in FIG. 1A.

FIG. 2A is a perspective view of an aluminum structural member according to a second exemplary configuration.

FIG. 2B is a sectional diagram taken along line II-II illustrated in FIG. 2A.

FIG. 3A is a perspective view of an aluminum structural member according to a third exemplary configuration.

FIG. 3B is a sectional diagram taken along line III-III illustrated in FIG. 3A.

FIG. 4A is a perspective view of an aluminum structural member according to a fourth exemplary configuration.

FIG. 4B is a sectional diagram taken along line IV-IV illustrated in FIG. 4A.

FIG. 5A is a perspective view of an aluminum structural member according to a fifth exemplary configuration.

FIG. 5B is a sectional diagram taken along line V-V illustrated in FIG. 5A.

FIG. 6A is a perspective view of an aluminum structural member according to a sixth exemplary configuration.

FIG. 6B is a sectional diagram taken along line VI-VI illustrated in FIG. 6A.

FIG. 7A is a perspective view of an aluminum structural member according to a seventh exemplary configuration.

FIG. 7B is a sectional diagram taken along line VII-VII illustrated in FIG. 7A.

FIG. 8A is a perspective view of an aluminum structural member according to an eighth exemplary configuration.

FIG. 8B is a sectional diagram taken along line VIII-VIII illustrated in FIG. 8A.

FIG. 9A is a perspective view of an aluminum structural member according to a ninth exemplary configuration.

FIG. 9B is a sectional diagram taken along line IX-IX illustrated in FIG. 9A.

FIG. 10A is a perspective view of an aluminum structural member according to a tenth exemplary configuration.

FIG. 10B is a sectional diagram taken along line X-X illustrated in FIG. 10A.

FIG. 11 is a perspective view of an aluminum structural member according to an eleventh exemplary configuration.

FIG. 12A is a perspective view of an aluminum structural member according to a twelfth exemplary configuration.

FIG. 12B is a sectional diagram taken along line XII-XII illustrated in FIG. 12A.

FIG. 13 is a perspective view of an aluminum structural member according to a thirteenth exemplary configuration.

FIG. 14A is a perspective view of an aluminum structural member according to a fourteenth exemplary configuration.

FIG. 14B is a sectional diagram taken along line XIV-XIV illustrated in FIG. 14A.

FIG. 15A is a sectional diagram of an aluminum wrought material having a through hole and that is wrapped with an aluminum-alloy casting such that the front and back surfaces thereof are covered.

FIG. 15B is a sectional diagram of the aluminum wrought material having the through hole, with only one side thereof being covered by the aluminum-alloy casting.

FIG. 16A is a perspective view of an aluminum structural member according to a fifteenth exemplary configuration.

FIG. 16B is a sectional diagram taken along line XVI-XVI illustrated in FIG. 16A.

FIG. 17A is a side view of an aluminum-alloy casting portion provided inside the aluminum structural member according to the fifteenth exemplary configuration that is seen from one side in the axial direction.

FIG. 17B is a side view of a modification of the aluminum-alloy casting portion illustrated in FIG. 17A.

FIG. 18A is a perspective view of an aluminum structural member according to a sixteenth exemplary configuration.

FIG. 18B is a sectional diagram taken along line XVIII-XVIII illustrated in FIG. 18A.

FIG. 19A is a perspective view of an aluminum structural member according to a seventeenth exemplary configuration.

FIG. 19B is a sectional diagram taken along line XIX-XIX illustrated in FIG. 19A.

FIG. 20A is a perspective view of an aluminum structural member according to an eighteenth exemplary configuration.

FIG. 20B is a sectional diagram taken along line XX-XX illustrated in FIG. 20A.

FIG. 21A is a front view illustrating a modification of a cast portion included in the aluminum structural member.

FIG. 21B is a side view of another modification of the cast portion included in the aluminum structural member.

FIG. 22 is a schematic front view of an instrument-panel reinforcement structure including an aluminum structural member according to a twentieth exemplary configuration that is seen from the inside of a vehicle cabin.

FIG. 23A is a perspective view of an aluminum structural member used in the evaluation of changes in hardness.

FIG. 23B is a sectional diagram taken along line XXIII-XXIII illustrated in FIG. 23A.

### DESCRIPTION OF EMBODIMENTS

Embodiments of the present invention will now be described in detail with reference to the drawings.

### <First Exemplary Configuration>

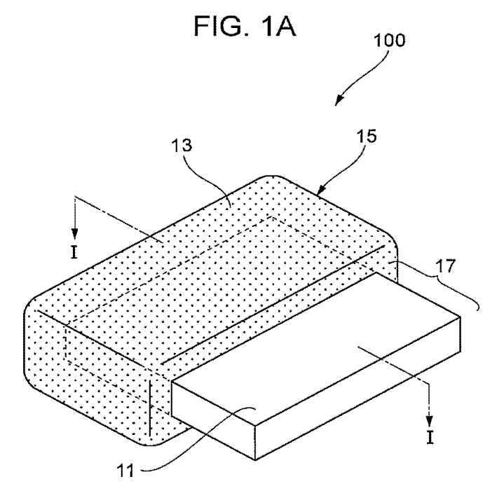

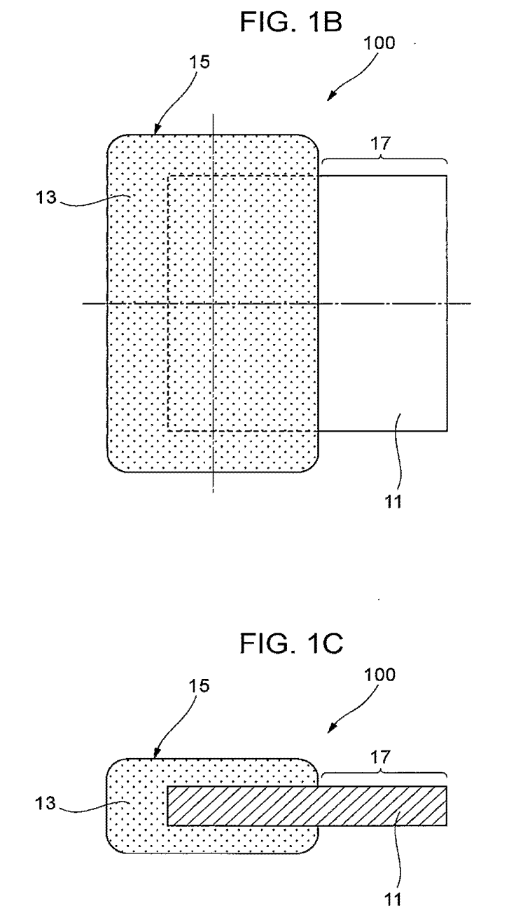

FIG. 1A is a diagram for describing an embodiment of the present invention and is a perspective view of an aluminum structural member according to a first exemplary configuration. FIG. 1B is a plan view of FIG. 1A. FIG. 1C is a sectional diagram taken along line I-I illustrated in FIG. 1A.

An aluminum structural member (aluminum component) 100 is configured such that an aluminum wrought material 11 made of aluminum or aluminum alloy is wrapped with an aluminum-alloy casting 13. The aluminum-alloy casting 13 wrapped around the aluminum wrought material 11 forms a cast portion 15 joined to the aluminum wrought material 11. The aluminum wrought material 11 includes a portion serving as a joining portion 17 that protrudes from the aluminum-alloy casting 13 to the outside.

The aluminum wrought material 11 is an aluminum rolled material, an extruded material, or a forged material. The aluminum wrought material 11 can be manufactured as, for example, a plate or a pipe (a round pipe, a rectangular pipe, or a deformed pipe). The aluminum wrought material 11 does not have any casting defect such as voids (cavities) in the material thereof, unlike a cast material, and therefore has excellent weldability and high dimensional accuracy. In the case of a casting, cutting is necessary for providing a joining surface of the joining portion 17 with satisfactory dimensional accuracy. In contrast, the aluminum wrought material 11 itself has high dimensional accuracy, with which the joining portion 17 can also have high dimensional accuracy even if the joining surface thereof is not machined (by cutting) that is performed in the case of the casting.

If a member having a combination of various shapes (such as a circular shape, a rectangular shape, a tapered shape, a ribbed shape, and so forth) is to be formed, it is easier to shape the aluminum-alloy casting 13, which is formed integrally by pouring molten metal into a mold, than to shape the wrought material through a plurality of steps. For example, the aluminum-alloy casting 13 can be easily formed into a member having a complicated shape, such as a cylinder head or a crankcase of an engine. Moreover, employing the aluminum-alloy casting 13 enables a highly rigid product as an integral structure to be manufactured with a relatively low cost. In the present configuration, molten aluminum alloy is caused to flow along a highly accurate wrought material, whereby the wrought material is wrapped with the aluminum alloy. Therefore, an aluminum structural member that is joinable to a joining portion of another joining-object member with high dimensional accuracy and that has high design flexibility in the shape thereof can be manufactured through a simple process.

In the aluminum structural member 100, the depth of fusion between the aluminum wrought material 11 and the aluminum-alloy casting 13 is adjustable by employing an arbitrary combination of materials for the aluminum wrought material 11 and the aluminum-alloy casting 13 that have different melting points or by arbitrarily combining the thickness of the aluminum wrought material 11 in the casting process. In such a case, the surface of the aluminum wrought material 11 may be in a brazed state in which the surface is barely melted. More preferably, the aluminum wrought material 11 may be fused in the thickness direction thereof with the aluminum-alloy casting 13 that is in a molten state, whereby a melt-solidified portion is formed. Thus, a structural member providing higher joining strength can be obtained.

The melting of the aluminum wrought material 11 in the casting process progresses in the thickness direction of the aluminum wrought material 11. The melt-solidified portion thus formed may be provided only in a surficial region or to the depth of the aluminum wrought material 11. That is, the melt-solidified portion may be formed at least in a region of the aluminum wrought material 11. Moreover, most part of the aluminum wrought material 11 may be fused into the molten metal while the original shape of the aluminum wrought material 11 is maintained.

The material for the aluminum wrought material 11 may be any of various alloy materials such as alloys of the AA6000 series, alloys of the 5000 series, alloys of the 7000 series, alloys of the 3000 series, and alloys of the 2000 series.

If at least one of the aluminum wrought material and the aluminum-alloy casting is a heat-treatable alloy of any of the 2000 series, the 6000 series, and the 7000 series, solution treatment and aging treatment may be performed after wrapping the aluminum alloy around the aluminum wrought material.

Solution treatment and aging treatment are applicable to each of aluminum structural members according to other exemplary configurations to be described below. In each of the exemplary configurations, the strength (hardness) of the aluminum structural member is improved, and more solid joining strength with respect to the joining-object member is obtained. In particular, if the Vickers hardness Hv is 60 or higher, a satisfactory level of strength is given to the aluminum structural member, providing high reliability.

The aluminum wrought material 11 is not limited to a plate material and may be an extruded material (a pipe material, or a shaped material that is hollow or solid or has a deformed cross section) or a forged material (a plate material or a ribbed material). The aluminum wrought material 11 may be subjected to any of surface treatments such as blasting, etching, brushing, and the like. Thus, organic substances on the surface of the aluminum wrought material 11 are removed, and the affinity between the aluminum wrought material 11 and molten aluminum (the wettability of molten aluminum) is increased.

The material for the aluminum-alloy casting 13 employed as the wrap may be any of AC4C, AC4CH, AC2B (JIS H 5202), ADC12 (JIS H 5302), and the like.

The method of forming the aluminum-alloy casting 13 may be any of various casting methods including metal-mold casting such as die casting, high-pressure casting, and the like; and sand-mold casting such as gravity casting and the like. In such a method, the aluminum wrought material 11 is set in a metal mold or a sand mold such that a portion thereof protrudes from the aluminum-alloy casting 13, and casting is performed. Thus, the aluminum structural member 100 according to the present exemplary configuration is obtained.

In the case of joining of a plurality of members, gaps may be produced between adjacent ones of the members, and water may enter such gaps and accelerate corrosion. In the aluminum structural member 100 according to the present configuration, the aluminum-alloy casting 13 is wrapped around the aluminum wrought material 11. That is, the aluminum wrought material 11 is covered by the aluminum-alloy casting with no gaps therebetween. Therefore, water entry is prevented.

Consequently, the occurrence of corrosion can be suppressed.

The aluminum structural member 100 configured as above offers a combination of an aluminum wrought material having high dimensional accuracy and an aluminum-alloy casting having a high flexibility in shape, increasing the design flexibility in the shape of the member. Furthermore, the aluminum structural member 100 is joinable to a joining-object member without using any adhesive or any mechanical fastening means such as bolts. Therefore, workability is increased.

<Second Exemplary Configuration>

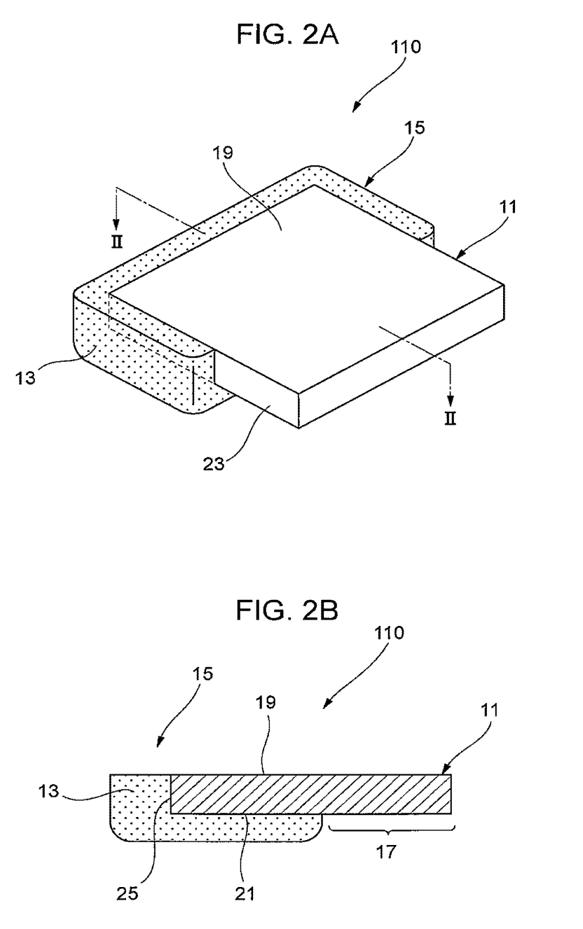

FIG. 2A is a perspective view of an aluminum structural member 110 according to a second exemplary configuration. FIG. 2B is a sectional diagram taken along line II-II illustrated in FIG. 2A. In the following description, like or corresponding members are denoted by like reference numerals, so that description of such members is simplified or omitted.

In the aluminum structural member 110 according to the present configuration including the aluminum wrought material 11 having a pair of upper and lower major surfaces, a pair of side surfaces, and a pair of end surfaces, one major-surface side of the aluminum wrought material 11 is wrapped with the aluminum-alloy casting 13. The aluminum-alloy casting 13 wrapped over the aluminum wrought material 11 forms the cast portion 15. The other major surface of the aluminum wrought material 11 according to the present configuration forms an exposed surface 19 that is exposed from the aluminum-alloy casting 13. In the aluminum wrought material 11, a portion of the one major surface (a lower surface 21 in FIG. 2A), a pair of parallel side surfaces 23 adjoining the lower surface 21, and an end surface 25 held between the pair of side surfaces 23 are wrapped with the aluminum-alloy casting 13.

As described above, the cast portion 15 may cover the front and back surfaces in the thickness direction and the side and end surfaces of the aluminum wrought material 11. Alternatively, the cast portion 15 may cover only part of the aluminum wrought material 11.

In the aluminum structural member 110 according to the present configuration, one surface of the aluminum wrought material 11 is not covered by the aluminum-alloy casting 13 and is exposed. Therefore, another joining-object member is joinable to the exposed part (surface) of the aluminum-alloy casting 13 by welding or the like. In that case, the joining-object member and a lap joint, a T-joint, or the like can be connected in any of various directions on a wide surface of the exposed part. Furthermore, according to the present configuration, the dimensional accuracy of the aluminum wrought material 11 itself can be utilized. That is, the parallelism with respect to the joining-object member can be enhanced easily without performing cutting. Therefore, the exposed part may also be used as a joining surface for mechanical fastening using bolts or the like.

Consequently, the process can be simplified.

In the aluminum structural member 110, the exposed part (exposed surface) of the aluminum wrought material 11 may be flush with the surface of the aluminum-alloy casting 13, may protrude from the surface of the aluminum-alloy casting 13, or may be recessed from the surface of the aluminum-alloy casting 13.

<Third Exemplary Configuration>

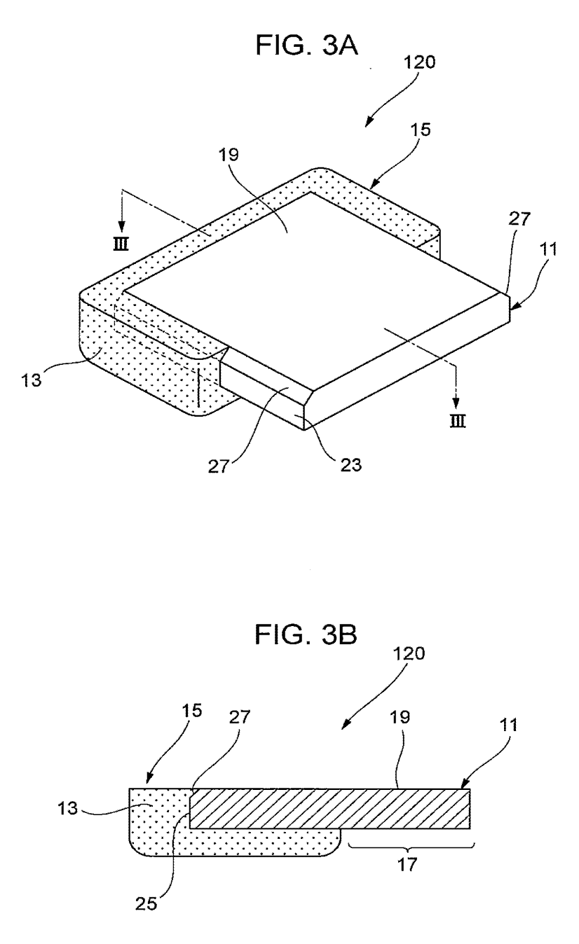

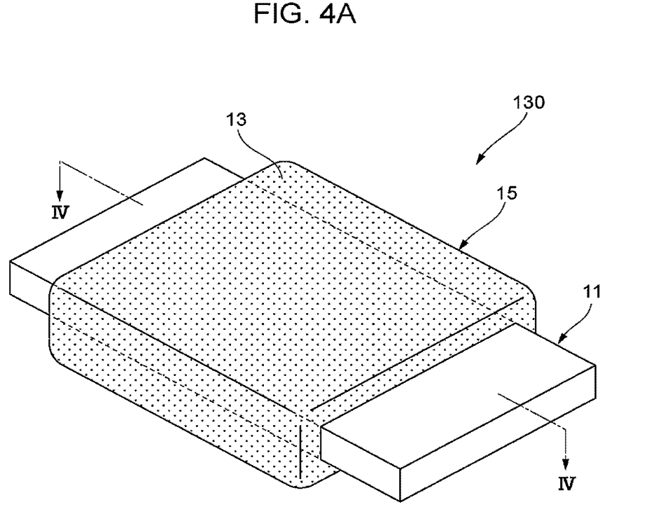

FIG. 3A is a perspective view of an aluminum structural member 120 according to a third exemplary configuration. FIG. 3B is a sectional diagram taken along line illustrated in FIG. 3A.

The aluminum structural member 120 according to the present configuration has the same configuration as the aluminum structural member 110 illustrated in FIG. 2A, except that chamfered portions 27 are provided at corners of the aluminum wrought material 11. The chamfered portions 27 are each provided at the corner, or the boundary, between the exposed surface 19 of the aluminum wrought material 11 and a corresponding one of the pair of parallel side surfaces 23 and the end surface 25 by cutting or grinding. The chamfered portions 27 may be formed by either R-chamfering or C-chamfering.

In the aluminum structural member 120 according to the present configuration, the aluminum wrought material 11 has the chamfered portions 27. Therefore, when the aluminum-alloy casting 13 is formed, molten metal can be made to run well. Since the molten metal can be made to run well in the aluminum structural member 120, gaps are less likely to be produced between the aluminum wrought material 11 and the aluminum-alloy casting 13. Moreover, the aluminum-alloy casting 13 covers the chamfered portions 27 of the aluminum wrought material 11. Therefore, the aluminum structural member 120 is less likely to come off in a direction perpendicular to the exposed surface 19 of the aluminum wrought material 11 than the aluminum structural member 110 according to the second exemplary configuration, and the torsional rigidity of the aluminum structural member 120 is increased.

<Fourth Exemplary Configuration>

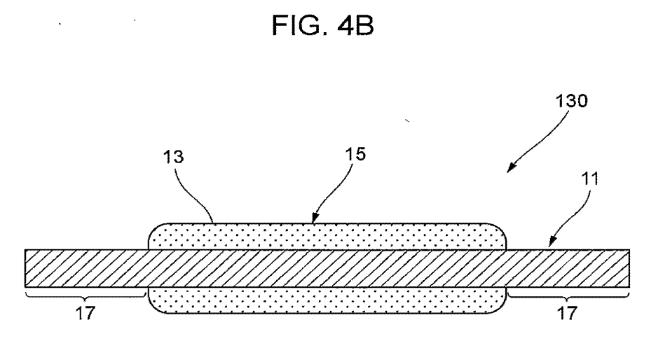

FIG. 4A is a perspective view of an aluminum structural member 130 according to a fourth exemplary configuration. FIG. 4B is a sectional diagram taken along line IV-IV illustrated in FIG. 4A.

The aluminum structural member 130 according to the present configuration is configured such that one aluminum wrought material 11 protrudes from two positions of the cast portion 15 formed of the aluminum-alloy casting 13, whereby joining portions 17 are provided. The aluminum-alloy casting 13 illustrated in the drawing has a simple shape as an example. Practically, the aluminum-alloy casting 13 may have a complicated shape including, for example, a base member having any of bolt-fastening portions, reinforcing ribs, and bolt holes.

In the aluminum structural member 130 according to the present configuration in which the aluminum wrought material 11 is wrapped with the aluminum-alloy casting 13, the pair of joining portions 17 protrude from the aluminum-alloy casting 13. If a joining-object member is joined to each of the pair of joining portions 17, a pair of joining-object members are joined to one shared member. Therefore, the pair of joining-object members can be joined while being positioned accurately. That is, joining accuracy is improved.

<Fifth Exemplary Configuration>

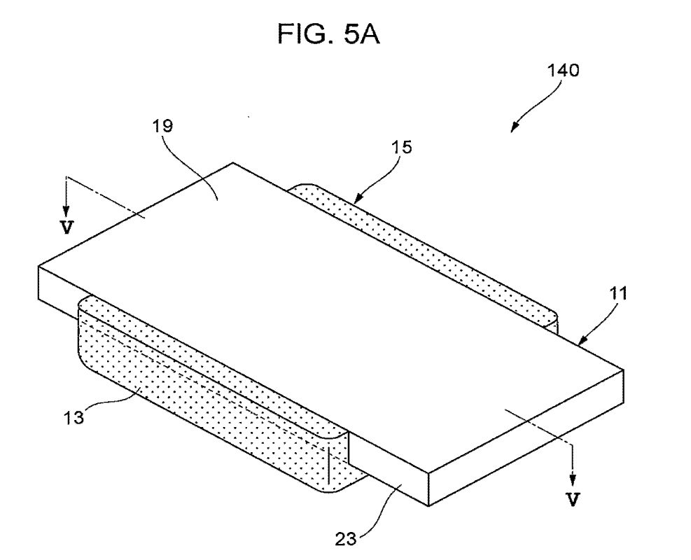

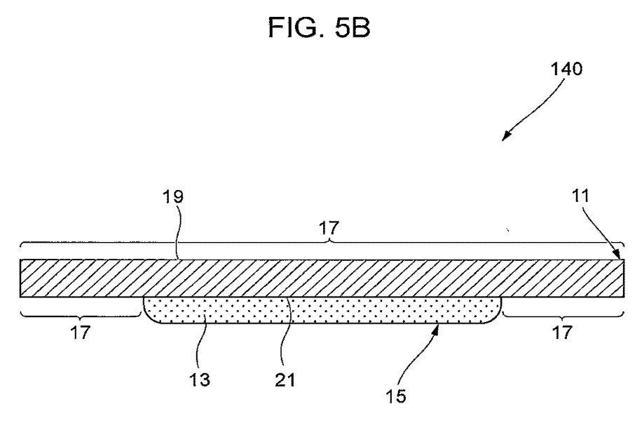

FIG. 5A is a perspective view of an aluminum structural member 140 according to a fifth exemplary configuration. FIG. 5B is a sectional diagram taken along line V-V illustrated in FIG. 5A.

The aluminum structural member 140 according to the present exemplary configuration has the same configuration as the aluminum structural member 130, except that one surface of the aluminum wrought material 11 of the aluminum structural member 130 illustrated in FIG. 4A is changed to an exposed surface 19. In the aluminum wrought material 11, a portion of the one major surface (the lower surface 21 in FIG. 5B) and the pair of parallel side surfaces 23 adjoining the lower surface 21 are wrapped with the cast portion 15 formed of the aluminum-alloy casting 13.

In the aluminum structural member 140 according to the present configuration, since the other major surface (the upper surface 19) of the aluminum wrought material 11 is exposed on the surface of the aluminum-alloy casting 13, a joining-object member can be joined to the exposed portion (surface) of the aluminum-alloy casting 13 by welding or the like. Furthermore, since the dimensional accuracy of the aluminum wrought material 11 itself can be utilized, the structural member can be assembled easily. In particular, since the two long-side ends of the aluminum wrought material 11 of the aluminum structural member 140 protrude from the aluminum-alloy casting 13, the joining portions 17 to be joined to joining-object members can have a large area.

<Sixth Exemplary Configuration>

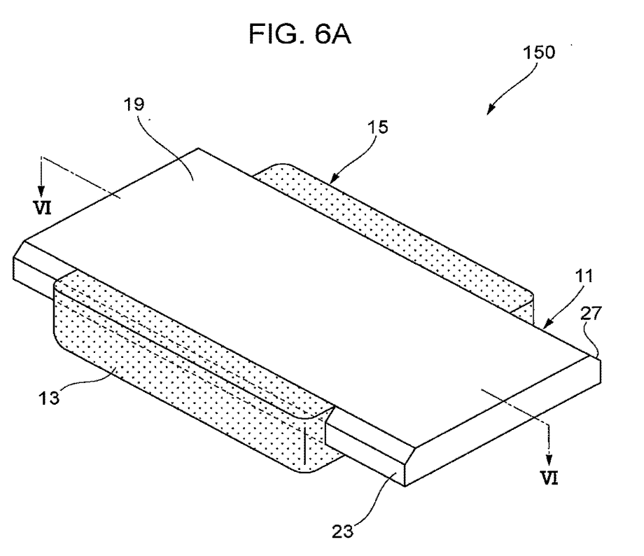

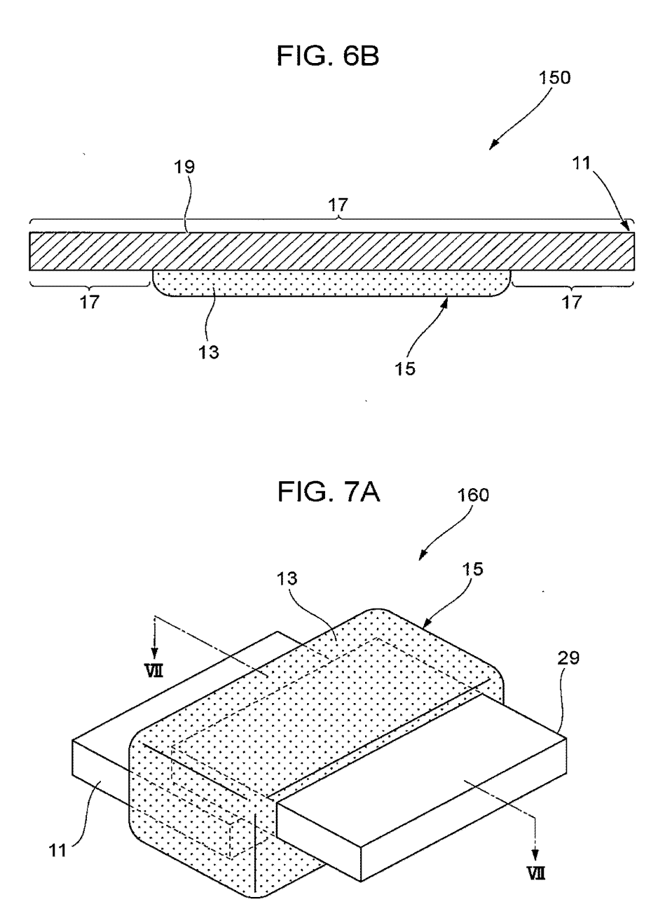

FIG. 6A is a perspective view of an aluminum structural member 150 according to a sixth exemplary configuration. FIG. 6B is a sectional diagram taken along line VI-VI illustrated in FIG. 6A.

The aluminum structural member 150 according to the present configuration has the same configuration as the aluminum structural member 140, except that chamfered portions 27 are provided to the aluminum wrought material 11 of the aluminum structural member 140 illustrated in FIG. 5A. The chamfered portions 27 are each provided by cutting or grinding the corner, or the boundary, between the exposed surface 19 of the aluminum wrought material 11 and a corresponding one of the pair of parallel side surfaces 23. The chamfered portions 27 may be formed by either R-chamfering or C-chamfering.

In the aluminum structural member 150 according to the present configuration, the aluminum wrought material 11 has the chamfered portions 27. Therefore, when the aluminum-alloy casting 13 is formed, molten metal can be made to run well. Moreover, in the aluminum structural member 150, the cast portion 15 formed of the aluminum-alloy casting 13 covers the chamfered portions 27 of the aluminum wrought material 11. Therefore, the aluminum structural member 150 is less likely to come off in a direction perpendicular to the exposed surface 19 of the aluminum wrought material 11 than the aluminum structural member 140 according to the fifth exemplary configuration, and the torsional rigidity of the aluminum structural member 150 is increased.

<Seventh Exemplary Configuration>

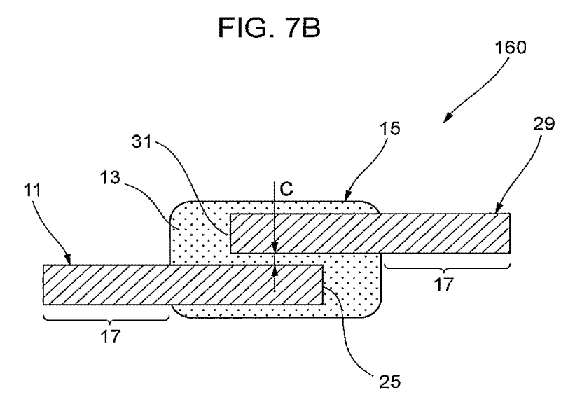

FIG. 7A is a perspective view of an aluminum structural member 160 according to a seventh exemplary configuration. FIG. 7B is a sectional diagram taken along line VII-VII illustrated in FIG. 7A.

In the aluminum structural member 160 according to the present configuration, a plurality of aluminum wrought materials 11 and 29 are inserted into an aluminum casting. The aluminum wrought material 11 and the aluminum wrought material 29 are made to extend parallel to each other and overlap each other with a clearance C therebetween. One end of the aluminum wrought material 11 on a side having an end surface 25 and one end of the aluminum wrought material 29 on a side having an end surface 31 are positioned inside the cast portion 15.

The other ends of the aluminum wrought materials 11 and 29 that are opposite the end surfaces 25 and 31 at the one ends are positioned on the outside of the aluminum-alloy casting 13 and serve as joining portions 17.

In the aluminum structural member 160 configured as above, the plurality of aluminum wrought materials 11 and 29 provided at respectively different arbitrary positions serve as joints that are joined to each other with the aid of the cast portion 15 formed of the aluminum-alloy casting 13.

The aluminum-alloy casting 13 is wrapped over one end of each of the aluminum wrought materials 11 and 29 and is provided in the space at the clearance C between the one ends of the two. Hence, the joining area between the aluminum-alloy casting and the plurality of aluminum wrought materials 11 and 29 is increased, and the aluminum wrought materials 11 and 29 can be joined to each other with high strength. Consequently, the strength of the aluminum structural member 160 as a whole is improved. Furthermore, since the aluminum wrought materials 11 and 29 can be positioned at a distance from each other, in a case where, for example, wrought materials whose axes are at different positions or extend in different directions are to be joined to each other, a joint having high flexibility in joint design and exhibiting high strength can be obtained easily.

Moreover, the aluminum structural member 160 is applicable not only to a case where plate-like wrought materials are to be joined to each other but also to a case where pipe-like wrought materials having different diameters are to be joined to each other at the outer peripheral surfaces thereof with the axes thereof being staggered.

Instead of the above configuration, the aluminum wrought materials 11 and 29 may be in close contact with each other, not being spaced apart from each other. In that case, the parallelism between the two can be maintained more accurately.

<Eighth Exemplary Configuration>

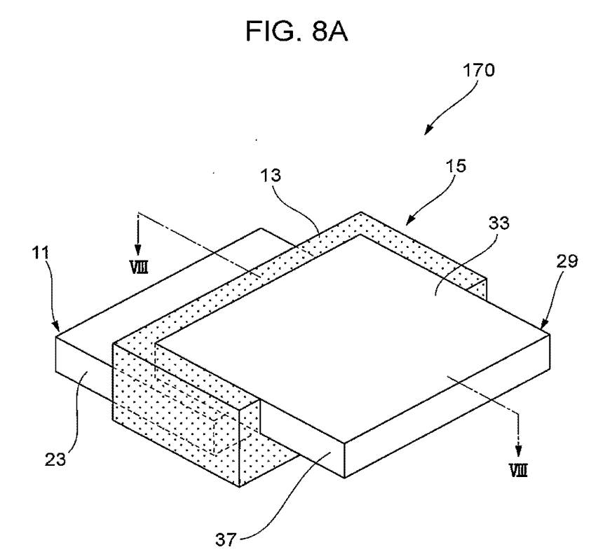

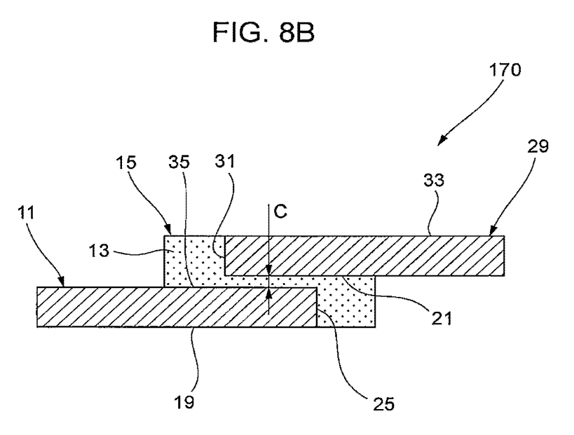

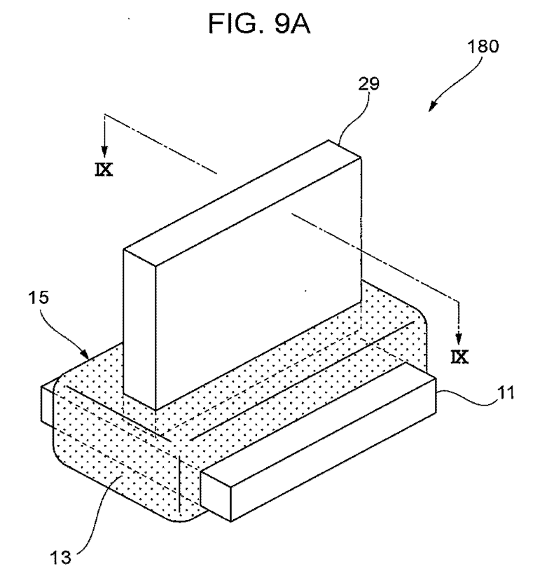

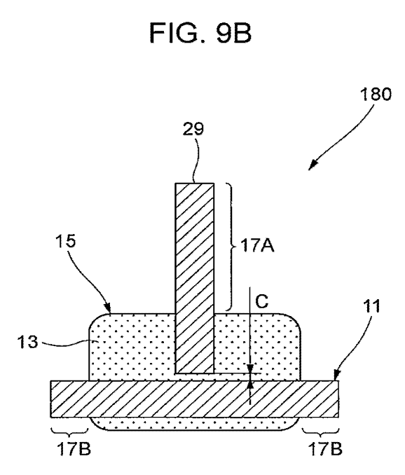

FIG. 8A is a perspective view of an aluminum structural member 170 according to an eighth exemplary configuration. FIG. 8B is a sectional diagram taken along line VIII-VIII illustrated in FIG. 8A.

In the aluminum structural member 170 according to the present configuration, the aluminum wrought materials 11 and 29 of the aluminum structural member 160 illustrated in FIG. 7A each have an exposed surface 19 or 33 on one side, or the back side, thereof. A portion of one major surface (an upper surface 35 in FIG. 8B), a pair of parallel side surfaces 23 adjoining the upper surface 35, and an end surface 25 of the aluminum wrought material 11 are wrapped with the cast portion 15 formed of the aluminum-alloy casting 13. A portion of one major surface (a lower surface 21 in FIG. 8B), a pair of parallel side surfaces 37 adjoining the lower surface 21, and an end surface 31 of the aluminum wrought material 29 are wrapped with the cast portion 15 formed of the aluminum-alloy casting 13. The aluminum wrought materials 11 and 29 are arranged with a clearance C therebetween in the thickness direction, with the space at the clearance C being filled with the aluminum-alloy casting 13.

In the aluminum structural member 170 according to the present configuration, the exposed surfaces 19 and 33 corresponding to the other major surfaces can each be utilized as an attaching surface to which a joining-object member is to be attached. In that case, the joining area with respect to the joining-object member is increased, and the joining strength can be increased. Furthermore, since the exposed surfaces 19 and 33 are made parallel to each other, the parallelism between the joining-object members can be enhanced.

Instead of the above configuration, the aluminum wrought materials 11 and 29 may be in close contact with each other, not being spaced apart from each other. In that case, the parallelism between the two can be maintained more accurately.

<Ninth Exemplary Configuration>

FIG. 9A is a perspective view of an aluminum structural member 180 according to a ninth exemplary configuration. FIG. 9B is a sectional diagram taken along line IX-IX illustrated in FIG. 9A.

In the aluminum structural member 180 according to the present configuration, a central portion of the rectangular plate-like aluminum wrought material 11 is wrapped with the aluminum-alloy casting 13. Two ends of the aluminum wrought material 11 in one direction protrude from the cast portion 15 and serve as joining portions 17. The cast portion 15 is also provided with another aluminum wrought material 29 extending in a direction perpendicular to the one direction of the aluminum wrought material 11. The aluminum wrought material 29 is cast together with the aluminum wrought material 11. One end of the aluminum wrought material 29 is wrapped with the cast portion 15 with a clearance C from the aluminum wrought material 11.

With the aluminum structural member 180 according to the present configuration, if, for example, joining portions 17A of the aluminum wrought material 11 are joined to a base material forming the aluminum-alloy casting 13 while a joining portion 17B of the aluminum wrought material 29 is joined to a joining-object member, the base member and the joining member can be connected to each other such that the respective joining surfaces of the two extend perpendicularly to each other.

Instead of the above configuration, the aluminum wrought materials 11 and 29 may be in close contact with each other, not being spaced apart from each other. In that case, the perpendicularity between the two can be maintained more accurately.

<Tenth Exemplary Configuration>

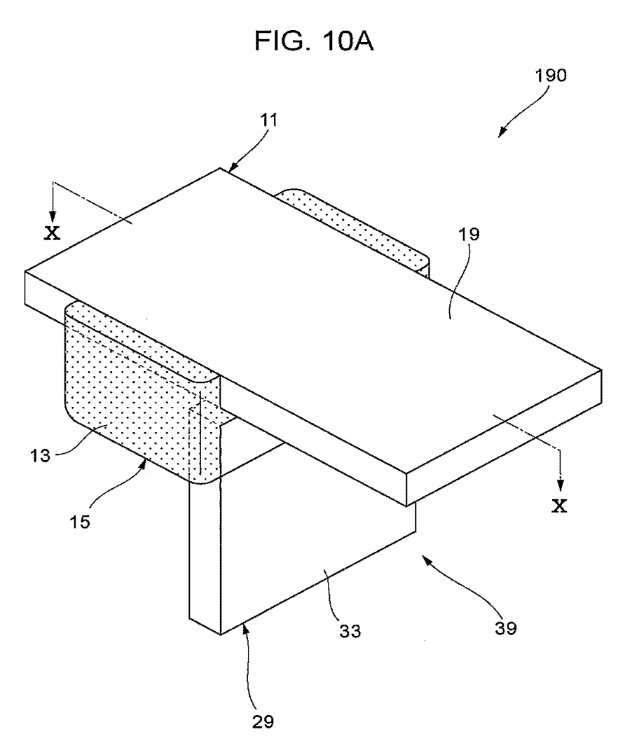

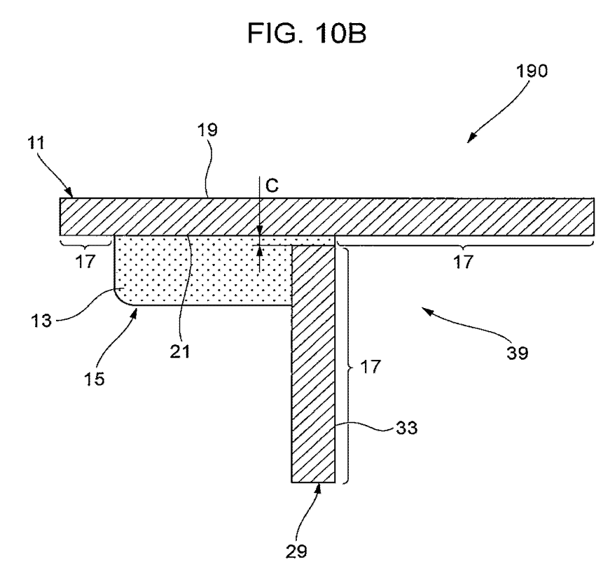

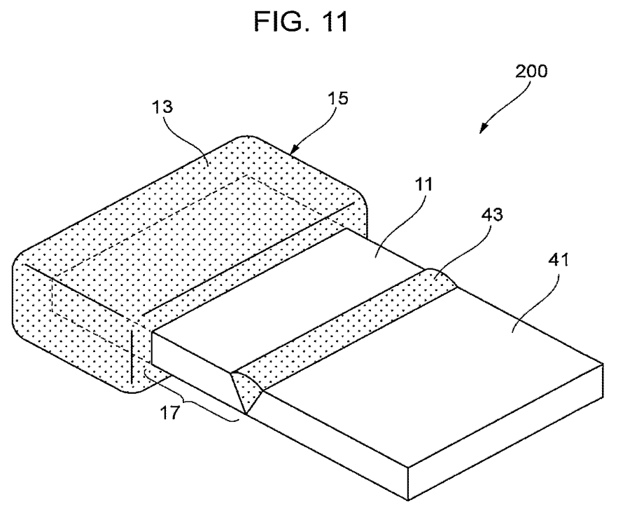

FIG. 10A is a perspective view of an aluminum structural member 190 according to a tenth exemplary configuration. FIG. 10B is a sectional diagram taken along line X-X illustrated in FIG. 10A.

In the aluminum structural member 190 according to the present configuration, the lower surface 21, illustrated in FIG. 10B, as one major surface of the rectangular plate-like aluminum wrought material 11 is wrapped with the aluminum-alloy casting 13. That is, the upper surface as the other major surface, illustrated in FIG. 10B, of the aluminum wrought material 11 forms an exposed surface 19. Furthermore, two ends of the aluminum wrought material 11 in the long-side direction protrude from the cast portion 15 and serve as joining portions 17. The cast portion 15 is also provided with another aluminum wrought material 29 extending in a direction perpendicular to the surface of the aluminum wrought material 11. The aluminum wrought material 29 is cast into the cast portion 15 with one end thereof being positioned with a clearance C from the aluminum wrought material 11. A surface (the major surface on the right side in FIG. 10B) of the aluminum wrought material 29 that is exposed outward from the cast portion 15 forms an exposed surface 33.

In the aluminum structural member 190 according to the present configuration, the entirety of the one major surface of each of the aluminum wrought material 11 and the aluminum wrought material 29 forms the exposed surface 19 or 33. Hence, the joining portions 17 can each have a large area. Furthermore, the aluminum structural member 190 forms a T-joint 39 in which the aluminum wrought material 11 and the aluminum wrought material 29 are arranged orthogonally to each other. If the aluminum structural member 190 as the T-joint 39 is joined to an external angle part of a joining-object member, the area of the joining surface with respect to the joining-object member can be increased, and high joining strength can be obtained.

Instead of the above configuration, the aluminum wrought materials 11 and 29 may be in close contact with each other, not being spaced apart from each other. In that case, the perpendicularity between the two can be maintained more accurately.

<Eleventh Exemplary Configuration>

FIG. 11 is a perspective view of an aluminum structural member 200 according to an eleventh exemplary configuration.

The aluminum structural member 200 according to the present configuration has the same configuration as the aluminum structural member 100 illustrated in FIG. 1, with a joining-object member 41 joined to the tip of the joining portion 17 of the aluminum wrought material 11 protruding from the cast portion 15, with a weld portion 43 interposed therebetween.

The joining portion 17 of the aluminum wrought material 11 has an inclined surface at the tip thereof. When the inclined surface is made to abut an inclined surface at the tip of the joining-object member 41, a groove is provided.

The aluminum wrought material 11 may be welded by, for example, MIG welding, in which the materials are deeply fused with each other. In the MIG welding of aluminum alloy, pure argon is used as shielding gas. The MIG welding is performed while an oxide film on the surface of a parent material is removed by utilizing a cleaning effect produced by an electric arc and while a solubilizer is added to the molten part.

In the aluminum structural member 200 according to the present configuration, the joining portion 17 can be used for butt welding with the joining-object member 41. Therefore, a portion that forms the joining portion 17 can be made much longer.

<Twelfth Exemplary Configuration>

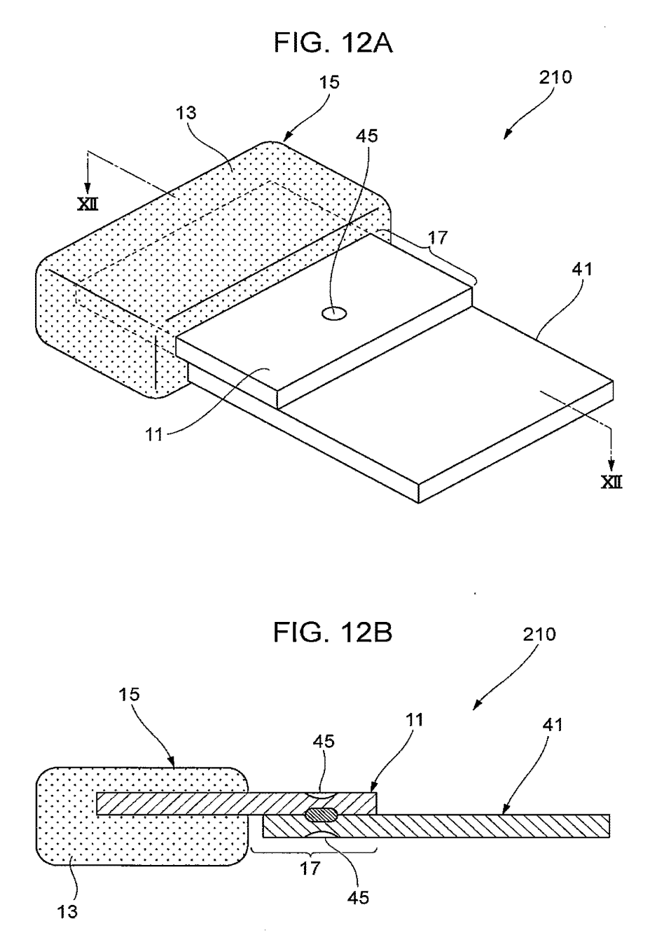

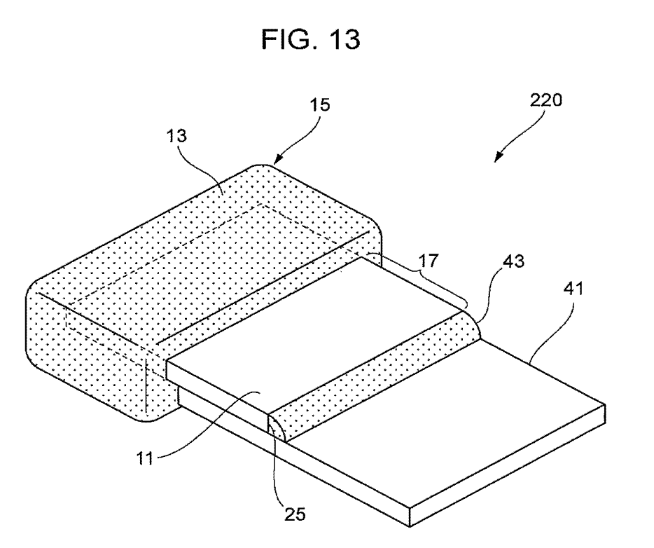

FIG. 12A is a perspective view of an aluminum structural member 210 according to a twelfth exemplary configuration. FIG. 12B is a sectional diagram taken along line XII-XII illustrated in FIG. 12A.

In the aluminum structural member 210 according to the present configuration, a joining-object member 41 is stacked, in the thickness direction, on the joining portion 17 of the aluminum wrought material 11 protruding from the cast portion 15 and is subjected to resistance spot welding. A welding mark 45 appears on a side of each of the joining portion 17 and the joining-object member 41 that is opposite the welded surface. The number and the positions of welded parts may be set arbitrarily in accordance with required strength.

In the aluminum structural member 210 according to the present configuration, the joining portion 17 of the aluminum wrought material 11 can be used for spot welding in which the joining portion 17 is stacked on the joining-object member 41 and the two are spot-welded. Therefore, a portion that forms the joining portion 17 can be made much longer.

<Thirteenth Exemplary Configuration>

FIG. 13 is a perspective view of an aluminum structural member 220 according to a thirteenth exemplary configuration.

In the aluminum structural member 220 according to the present configuration, a joining-object member 41 is stacked, in the thickness direction, on the joining portion 17 of the aluminum wrought material 11 protruding from the cast portion 15, and the two are subjected to MIG welding. The joining portion 17 is joined to the joining-object member 41 with the aid of a weld portion 43 that is formed in the MIG welding. The MIG welding may be performed not only between the end surface 25 of the joining portion 17 and one of the major surfaces of the joining-object member 41 that meets the end surface 25 but also between other portions to be joined.

The aluminum structural member 220 according to the present configuration can be used in MIG welding in which the joining portion 17 of the aluminum wrought material 11 is stacked on the joining-object member 41 and the two are subjected to MIG welding. Therefore, a portion that forms the joining portion 17 can be made much longer.

<Fourteenth Exemplary Configuration>

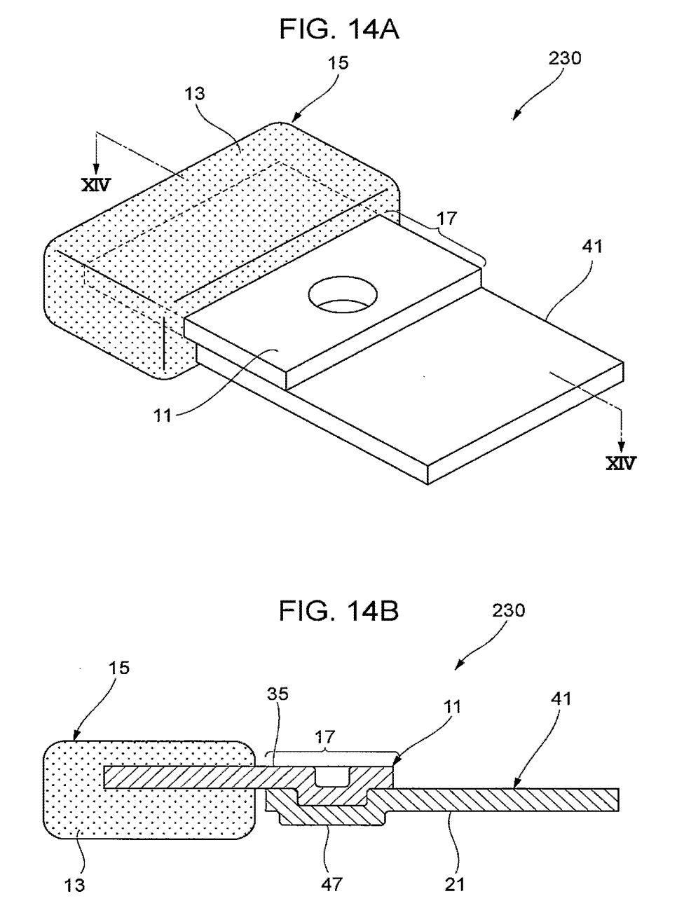

FIG. 14A is a perspective view of an aluminum structural member 230 according to a fourteenth exemplary configuration. FIG. 14B is a sectional diagram taken along line XIV-XIV illustrated in FIG. 14A.

In the aluminum structural member 230 according to the present configuration, a joining-object member 41 is stacked, in the thickness direction, on the joining portion 17 of the aluminum wrought material 11 protruding from the cast portion 15, and the two are subjected to clinch fastening. The drawing illustrates an exemplary clinch-fastened configuration employing a TOX (a registered trademark) clinch method. In the TOX (a registered trademark) clinch method, a die (not illustrated) is placed on the side of the lower surface 21 of the joining-object member 41 placed under the joining portion 17, and a pressure is applied by punching toward the die from the side of the upper surface 35 of the joining portion 17. Thus, the joining portion 17 and the joining-object member 41 are plastically deformed, whereby a punched recess 47 is provided. Subsequently, the lower surface of the punched recess 47 is squashed from the side of the lower surface 21 of the joining-object member 41, whereby the joining portion 17 and the joining-object member 41 are fastened to each other.

With the aluminum structural member 230 according to the present configuration, no welding heat is generated unlike the case of MIG welding, spot welding, or the like. Therefore, relevant members can be prevented from being thermally deformed. Furthermore, the aluminum structural member 230 does not require fastening members, such as rivets, screws, or the like, and requires only metal-plate plasticity. Therefore, the manufacturing cost can be reduced.

While the aluminum wrought material according to each of the above exemplary configurations is a flat plate-like member, the aluminum wrought material may have at least one through hole.

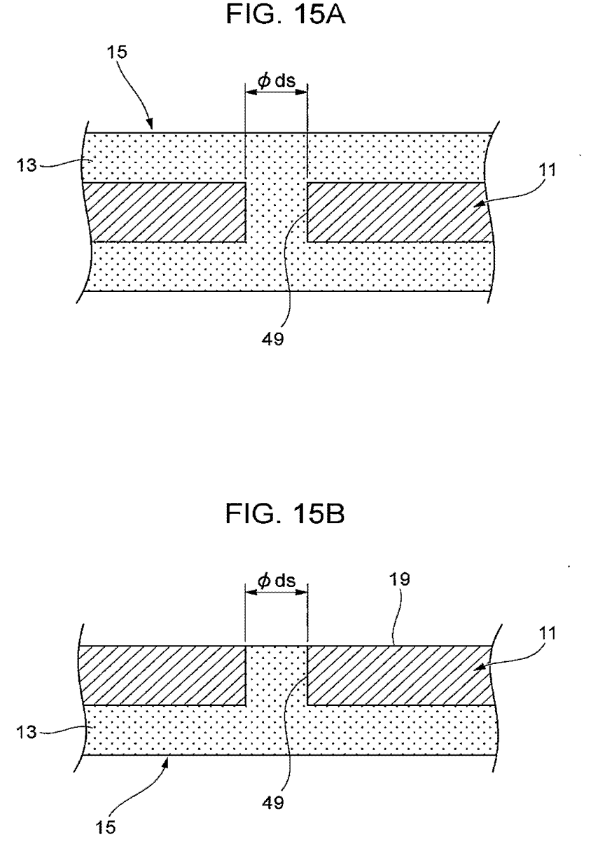

FIG. 15A is a sectional diagram of an aluminum wrought material 11 having a through hole 49 and that is wrapped by an aluminum-alloy casting 13 such that the front and back surfaces thereof are covered. The aluminum-alloy casting 13 in a molten state flows into and fills the through hole 49 in the process of insertion casting.

In this configuration, portions of the aluminum-alloy casting 13 that are present on the front and back sides of the aluminum wrought material 11 are connected to each other through the through hole 49. Hence, the portion of the aluminum-alloy casting 13 that is present in the through hole 49 serves as a locking portion, and the aluminum structural member can have much higher mechanical strength, such as tensile strength and bending strength, and much higher rigidity.

FIG. 15B is a sectional diagram of the aluminum wrought material 11 having the through hole 49, with only one side thereof being covered by the aluminum-alloy casting 13. The upper surface in the drawing forms an exposed surface 19 of the aluminum wrought material 11. In such a case also, the portion of the aluminum-alloy casting 13 that is present in the through hole 49 serves as a locking portion, further increasing the mechanical strength, such as tensile strength and bending strength, and the rigidity. In addition, the exposed surface may be joined to another member (a wrought material) or the like by welding or the like.

The number of through holes 49, the positions of the through holes 49, and the diameter φds of each through hole 49 may be adjusted arbitrarily in accordance with the usage and the site of application. Thus, the optimum joining strength can be obtained.

The shape of the through hole 49 is not limited to a circular shape as illustrated and may be any shape such as a rectangular shape, an oblong shape, or the like. Moreover, the sectional shape of the hole is not limited to a cylindrical shape and may be a tapered shape, a shape with a portion protruding inward in the middle part thereof in the thickness direction, a shape with an increased area of the inner surface thereof, or a shape with an inclined surface. In such a case, the joining strength between the inner wall surface of the hole and the aluminum-alloy casting material is further increased, and the mechanical strength with respect to the aluminum-alloy casting 13 can further be improved.

In addition, the through hole 49 may be a non-through hole in the form of a recess provided only in either of the major surfaces of the aluminum wrought material 11. In such a configuration also, the aluminum-alloy casting 13 that fills the recess serves as a locking portion, further increasing the mechanical strength such as tensile strength and bending strength.

Now, a cylindrical aluminum structural member will be described.

<Fifteenth Exemplary Configuration>

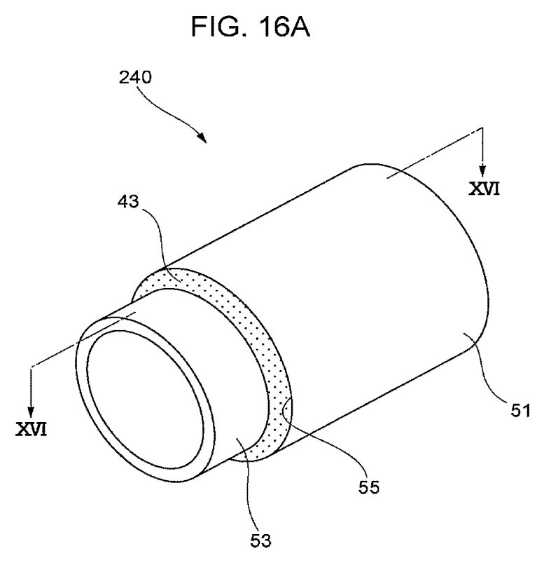

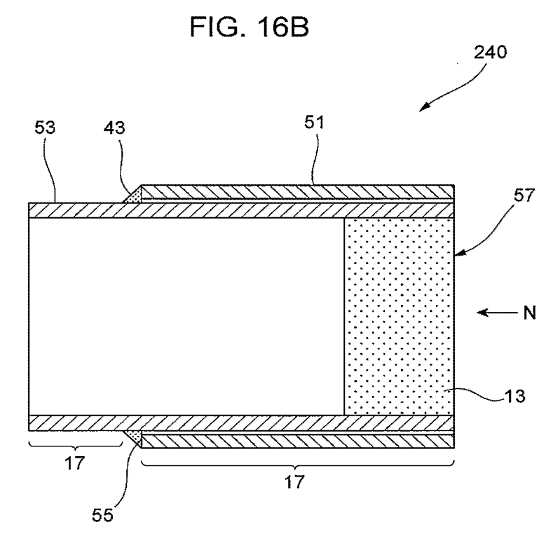

FIG. 16A is a perspective view of an aluminum structural member 240 according to a fifteenth exemplary configuration. FIG. 16B is a sectional diagram taken along line XVI-XVI illustrated in FIG. 16A.

The aluminum structural member 240 according to the present configuration includes an aluminum wrought material 51 having a cylindrical shape. In the aluminum structural member 240, an aluminum wrought material 53 as an inner cylinder having a small diameter is fitted in the aluminum wrought material 51 as an outer cylinder having a large diameter. An end surface 55 of the aluminum wrought material 51 is welded to the outer peripheral surface of the aluminum wrought material 53, whereby annular weld portion 43 is formed. A columnar cast portion (inserted portion) 57 formed of the aluminum-alloy casting 13 is provided inside the aluminum wrought material 53.

The aluminum structural member 240 may be obtained by forming the cast portion 57 in the aluminum wrought material 53 as the inner cylinder, providing the aluminum wrought material 51 as the outer cylinder thereover, and welding the end surface 55. The cast portion 57 according to the present configuration is a solid structure, and a surface thereof formed at the end of the aluminum wrought material 53 is flat.

In the aluminum structural member 240 according to the present configuration, the aluminum wrought material 51 having a large diameter and the aluminum wrought material 53 having a small diameter provide respective joining portions 17 arranged coaxially with each other and having different outside diameters. Utilizing the difference in the outside diameters of the aluminum wrought materials 51 and 53, the aluminum structural member 240 can be used as a joint for joining, for example, pipes having different diameters. Moreover, the design flexibility in the shape of a member whose shape changes significantly, for example, from a large-diameter portion to a small-diameter portion in the long-side direction can be increased, and the strength at the junction between the wrought material and the casting can be increased.

The cast portion (inserted portion) in the above configuration is not limited to a solid structure.

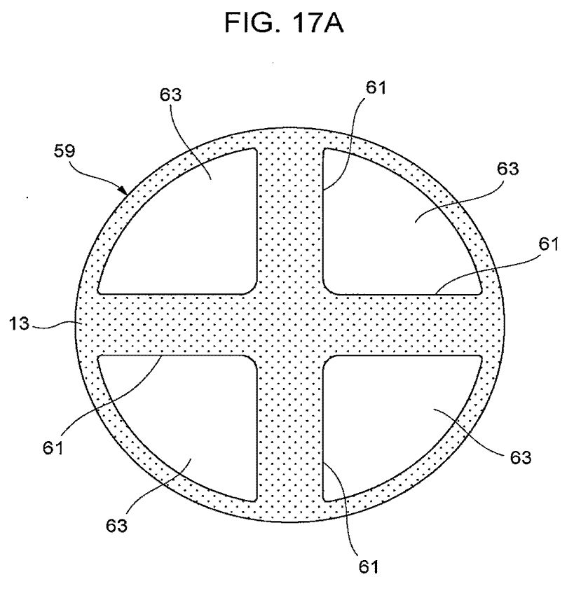

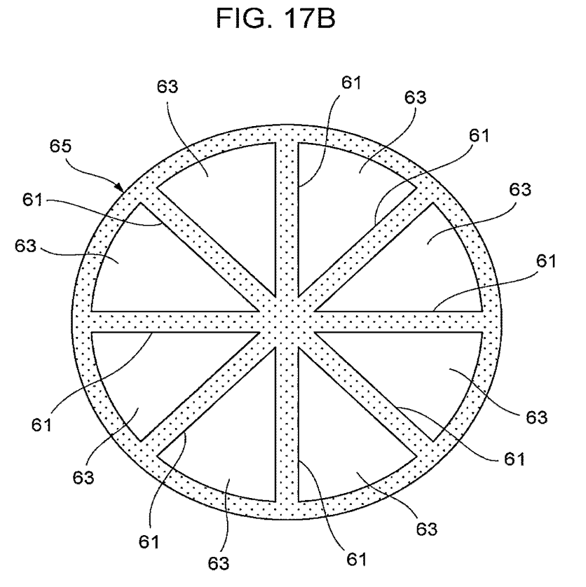

FIG. 17A is a side view of an aluminum-alloy casting portion provided inside the aluminum structural member according to the fifteenth exemplary configuration that is seen from one side in the axial direction (in the direction of arrow N).

The aluminum-alloy casting portion (inserted portion) 59 illustrated in the drawing has reinforcing ribs 61 arranged in a cross shape. When the cast portion 57 of the aluminum structural member 240 illustrated in FIG. 16B is formed, substantially triangular-pole-shaped hollow spaces 63 are provided by using cores or the like, and the cast portion 57 is made to pass through the aluminum-alloy casting portion 59, whereby the reinforcing ribs 61 are obtained.

FIG. 17B is a side view of a modification of the aluminum-alloy casting portion illustrated in FIG. 17A.

An aluminum-alloy casting portion 65 according to the present modification includes reinforcing ribs 61 that are arranged radially. As with the case of the above configuration, the reinforcing ribs 61 are formed by using cores or the like.

With the aluminum-alloy casting portion 59 or 65 according to the above configuration, a weight reduction and a cost reduction by reducing the volume of the aluminum-alloy casting 13 are realized.

<Sixteenth Exemplary Configuration>

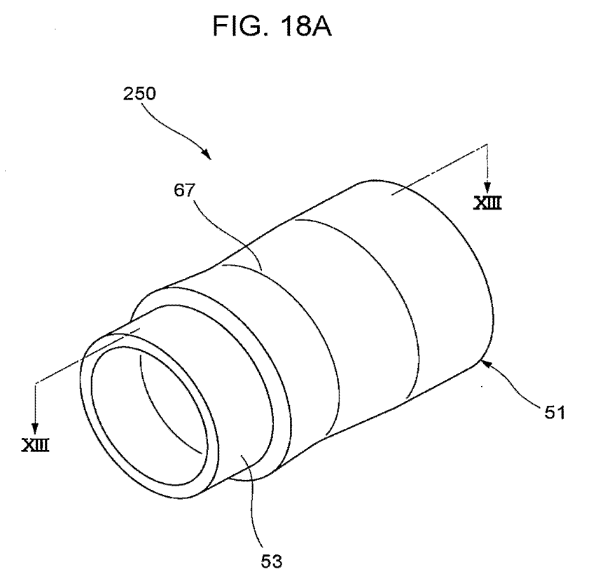

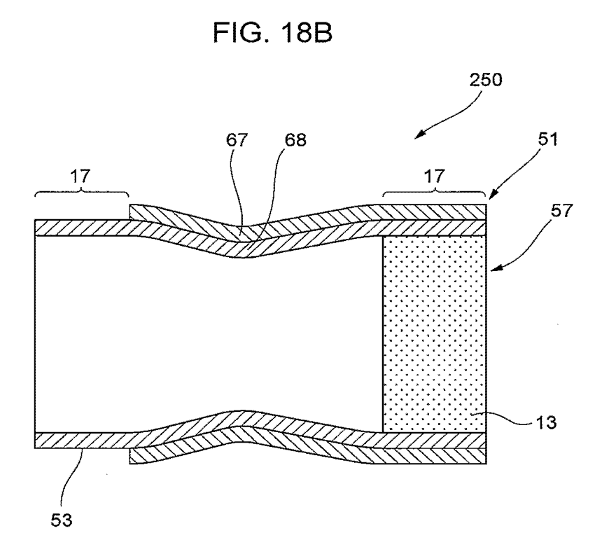

FIG. 18A is a perspective view of an aluminum structural member 250 according to a sixteenth exemplary configuration. FIG. 18B is a sectional diagram taken along line XVIII-XVIII illustrated in FIG. 18A.

In the aluminum structural member 250 according to the present configuration, a cast portion 57 is provided in the bore of an aluminum wrought material 53 as an inner cylinder having a small diameter, and an aluminum wrought material 51 as an outer cylinder having a large diameter is provided over the outer periphery of the aluminum wrought material 53. The aluminum wrought material 51 includes a narrowed portion 67 formed by reducing the outside diameter thereof in a region in the axial direction. The aluminum wrought material 53 includes a similar narrowed portion 68. The outer peripheral surface of the aluminum wrought material 53 is inserted in the axial direction into the inner peripheral surface of the aluminum wrought material 51. At a position where the narrowed portions 67 and 68 overlap each other, the aluminum wrought materials 51 and 53 are fixed to each other by being clinched.

In the aluminum structural member 250 according to the present configuration, the aluminum wrought material 51 and the aluminum wrought material 53 provide respective joining portions 17 arranged coaxially with each other and having different outside diameters can be obtained. Utilizing the difference in the outside diameters of the aluminum wrought material 51 and the aluminum wrought material 53, the aluminum structural member 250 can be used as a joint for joining, for example, pipes having different diameters. Moreover, in the aluminum structural member 180, the aluminum wrought material 51 and the aluminum wrought material 53 are joinable to each other not by the method such as MIG welding, resistance spot welding, or the like. Hence, the occurrence of thermal distortion can be suppressed. Furthermore, the manufacturing cost can be made lower than that in the case of welding.

<Seventeenth Exemplary Configuration>

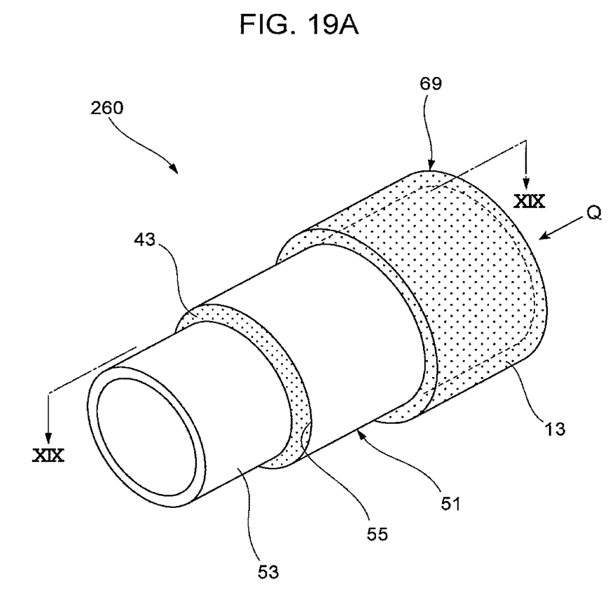

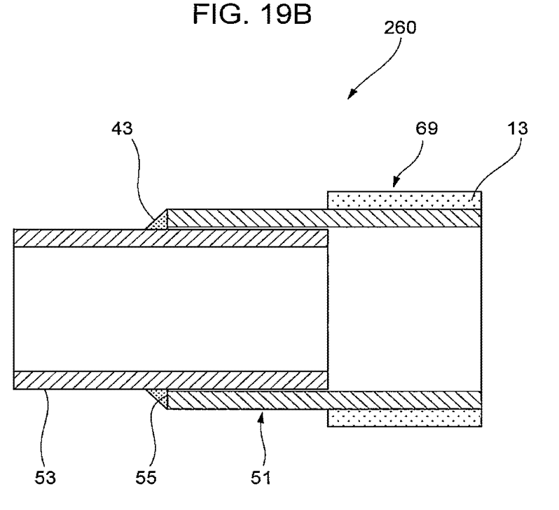

FIG. 19A is a perspective view of an aluminum structural member 260 according to a seventeenth exemplary configuration. FIG. 19B is a sectional diagram taken along line XIX-XIX illustrated in FIG. 19A.

In the aluminum structural member 260 according to the present configuration, an aluminum wrought material 53 having a small diameter is fitted in an aluminum wrought material 51 having a large diameter. A portion of the aluminum wrought material 53 is exposed from the aluminum wrought material 51. An end surface 55 of the aluminum wrought material 51 is joined to the outer peripheral surface of the aluminum wrought material 53 by MIG welding or the like. Thus, an annular weld portion 43 is formed at the end surface 55. With a portion of the aluminum wrought material 51 having a large diameter being exposed, a cylindrical cast portion 69 is formed from the aluminum-alloy casting 13 on the outer periphery at one end of the aluminum wrought material 51. The aluminum wrought material 53, the aluminum wrought material 51, and the cast portion 69 are arranged coaxially.

The aluminum structural member 260 according to the present configuration allows a joining-object member to be joined to the aluminum wrought material 53 thereof, serving as a joining portion, with high accuracy. Furthermore, with the cast portion 69, the aluminum structural member 260 is provided as a multi-diameter light-weight tubular member that is fixable to another site.

<Eighteenth Exemplary Configuration>

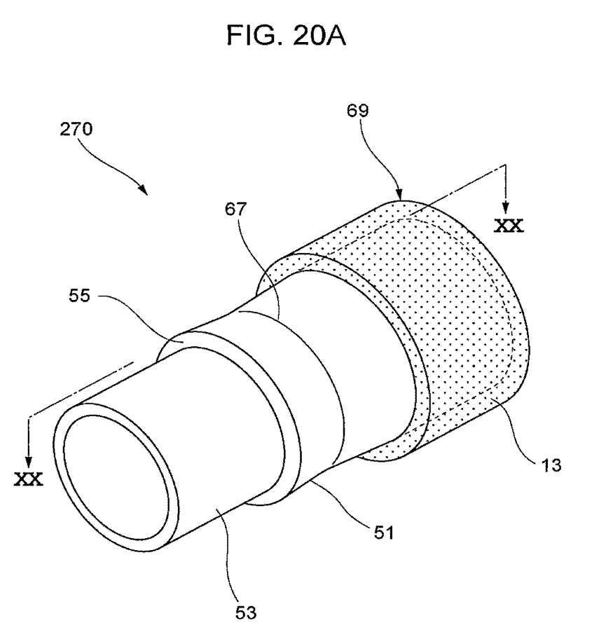

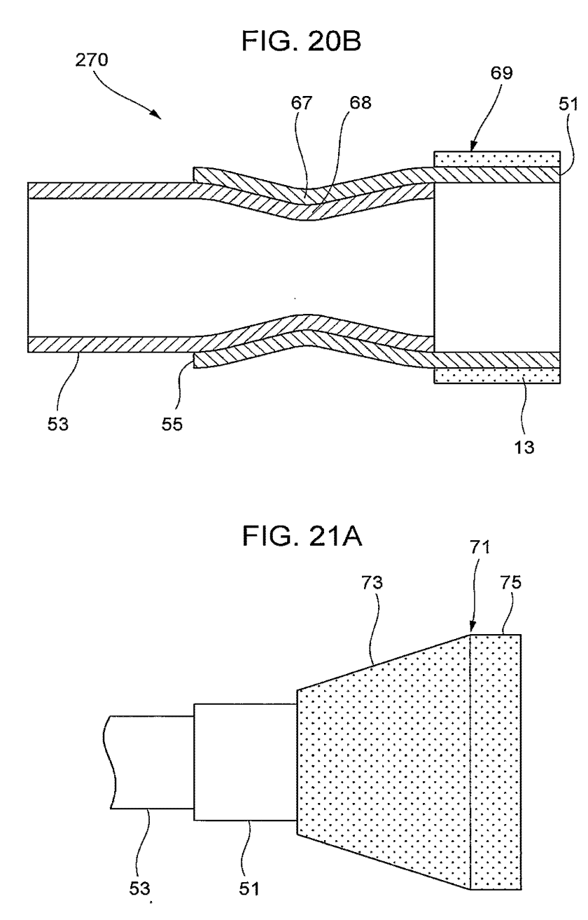

FIG. 20A is a perspective view of an aluminum structural member 270 according to an eighteenth exemplary configuration. FIG. 20B is a sectional diagram taken along line XX-XX illustrated in FIG. 20A.

In the aluminum structural member 270 according to the present configuration, the aluminum wrought material 51 having a large diameter illustrated in FIG. 19B is fixed to the outer periphery of the aluminum wrought material 53 having a small diameter at the narrowed portions 67 and 68. The narrowed portions 67 and 68 are each a portion of a corresponding one of the aluminum wrought material 51 and the aluminum wrought material 53 where the diameter thereof is reduced over the entire periphery in a region thereof in the axial direction. The aluminum wrought material 51 and the aluminum wrought material 53 are fixed to each other at the narrowed portions 67 and 68.

The aluminum structural member 270 according to the present configuration can be manufactured easily by fixing the aluminum wrought material 51 and the aluminum wrought material 53 to each other by clinching. Furthermore, the aluminum structural member 270 according to the present configuration allows a joining-object member to be joined to the aluminum wrought material 53 thereof, serving as the junction, with high accuracy. Furthermore, with the cast portion 69, the aluminum structural member 270 is provided as a multi-diameter light-weight tubular member that is fixable to another site.

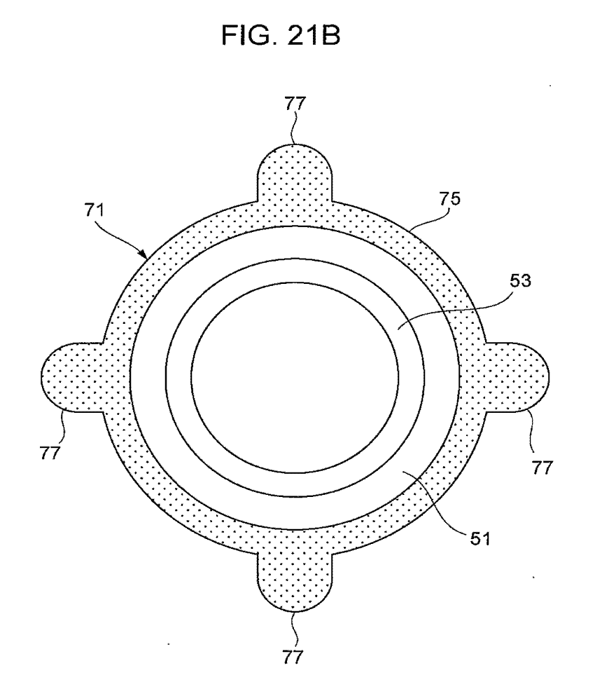

FIG. 21A is a front view illustrating a modification of the cast portion included in the aluminum structural member 270.

In this aluminum structural member, an aluminum wrought material 53 having a small diameter is fitted into one end of an aluminum wrought material 51 having a large diameter. The aluminum wrought material 51 and the aluminum wrought material 53 may be joined to each other by either welding or clinching. The aluminum wrought material 51 having a large diameter is provided at the other end thereof with a cast portion 71 according to the present modification, the cast portion 71 extending along the outer periphery thereof.

The cast portion 71 includes a tapered portion 73 whose outside diameter gradually increases in the axial direction of the aluminum wrought material 51. As illustrated in the drawing, an outside diameter portion 75 continuous with the tapered portion 73 and having a uniform diameter may be provided.

With the cast portion 71 according to the present modification, the aluminum wrought material 51 having a large diameter and the outside diameter portion 75 having a uniform diameter are integrated with each other by the tapered portion 73, providing a single multi-diameter tubular member. Furthermore, the cast portion 71 can be joined to another member by utilizing the tapered portion 73.

FIG. 21B is a side view of another modification of the cast portion included in the aluminum structural member 270.

The cast portion 71 according to the present modification includes a plurality of (four in the example illustrated in the drawing) reinforcing ribs 77 provided on the outside diameter portion 75 of the cast portion 69, illustrated in FIG. 20A, and extending along the axial line. The reinforcing ribs 77 are each a protrusion-type rib that protrudes radially outward and are arranged at regular intervals in the circumferential direction.

The aluminum structural member according to the present modification exhibits increased strength of the cast portion 71. Accordingly, the rigidity and the load bearing of the aluminum structural member can be increased.

If the aluminum-alloy casting 13 is wrapped with the aluminum wrought material 51 or the aluminum wrought material 53 having a cylindrical shape, the aluminum wrought material 51 or the aluminum wrought material 53 preferably has the above through hole 49 (see FIGS. 15A and 15B). Filling the through hole 49 with the aluminum-alloy casting 13 further increases the joining strength between the aluminum wrought material 51 or the aluminum wrought material 53 and the cast portion.

<Nineteenth Exemplary Configuration>

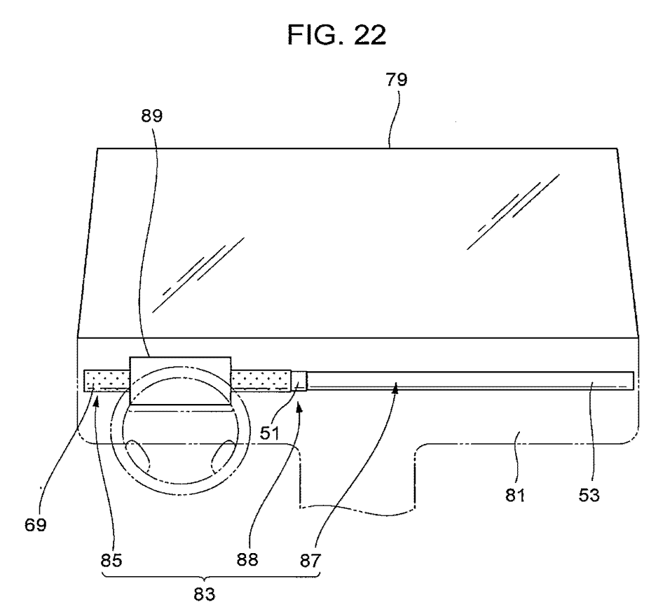

FIG. 22 is a schematic front view of an instrument-panel reinforcement structure including the aluminum structural member that is seen from the inside of a vehicle cabin.

A vehicle such as an automobile includes a windshield 79 provided on the upper side of the front portion of a cabin thereof in the front-back direction of the vehicle, and an instrument panel 81 provided below the windshield 79.

The instrument panel 81 is attached to an instrument-panel reinforcement 83 included in the instrument-panel reinforcement structure. The instrument-panel reinforcement 83 is formed of hollow metal made of aluminum alloy, iron, or the like and bridges right and left front pillars, which are not illustrated.

The instrument-panel reinforcement 83 includes a large-diameter portion 85 provided on one-end side thereof, which corresponds to the side of a housing 89, a small-diameter portion 87 provided on the other-end side thereof, and a connecting portion 88 that connects the large-diameter portion 85 and the small-diameter portion 87 to each other. The instrument-panel reinforcement 83 includes the above-described cylindrical aluminum structural member 260 or 270 (see FIGS. 19A and 19B) and so forth. That is, the large-diameter portion 85 corresponds to the cast portion 69, the small-diameter portion 87 corresponds to the aluminum wrought material 53, and the portion between the large-diameter portion 85 and the small-diameter portion 87 corresponds to the aluminum wrought material 51. In this configuration, there is no need to perform work (pipe squeezing or the like) on the end of the large-diameter portion 85 in conformance with the shape of the small-diameter portion 87, and members having different outside diameters can be assuredly connected to each other with high workability.

Furthermore, applying the aluminum structural member configured as above to the instrument-panel reinforcement 83 enables the instrument-panel reinforcement 83 to be light-weight and to have high joining strength and high rigidity.

The present invention is not limited to the above embodiments and assumes various combinations of features of the above embodiments and various changes and applications of the above embodiments that may be made by those skilled in the art on the basis of the description provided in this specification and known techniques. Such combinations, changes, and applications are included in the scope of the claims.

The above aluminum structural member is applicable not only to the instrument-panel reinforcement but also to any other member. Furthermore, the above aluminum structural member is applicable not only to a member included in a vehicle such as an automobile but also to a structural member or the like included in a transporting machine such as a vessel or an aircraft, a construction machine, or any of other various apparatuses.

### Examples

Now, the results of changes in the hardness of the above aluminum structural member that occurred when solution treatment and aging treatment were given to the aluminum structural member will be described.

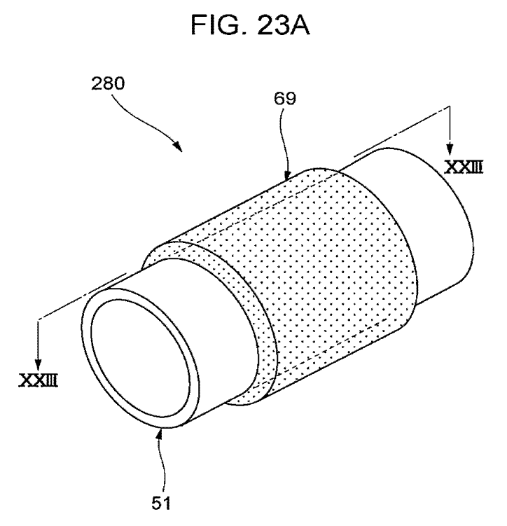

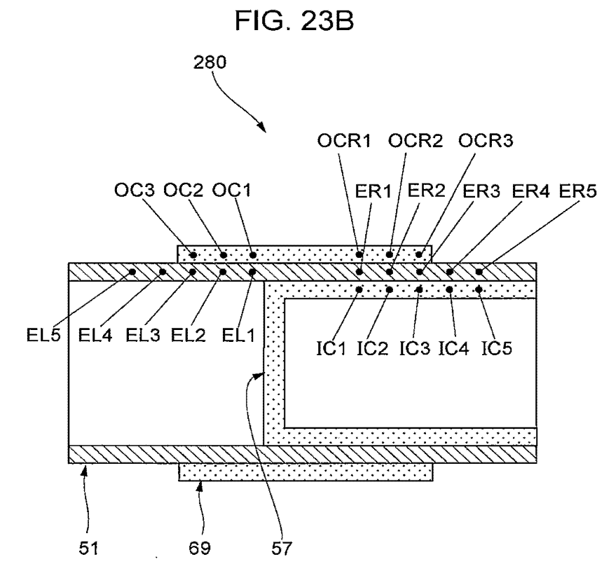

In the following examples, solution treatment and aging treatment were given to an aluminum structural member illustrated in FIGS. 23A and 23B.

FIG. 23A is a perspective view of an aluminum structural member 280 used in the evaluation of changes in hardness. FIG. 23B is a sectional diagram taken along line XXIII-XXIII illustrated in FIG. 23A.

The aluminum structural member 280 includes a cylindrical aluminum wrought material 51, a cast portion 57 serving as a bottomed cylindrical supporting member and fitted in the aluminum wrought material 51, and a cylindrical cast portion 69 provided over the aluminum wrought material 51 at a position corresponding to the cast portion 57. The cast portions 57 and 69 are each an aluminum-alloy casting and are positioned such that at least respective portions thereof overlap each other in the thickness direction in a region of the aluminum wrought material 51 in the long-side direction.

The cast portion 57 serving as the supporting member was formed by inserting a pair of cores into a position radially inside the cylindrical aluminum wrought material 51 and supplying aluminum alloy into cavities thus provided. The pair of cores include one core having an outside diameter that is substantially the same as the inside diameter of the aluminum wrought material 51, and the other core having a diameter smaller than that of the one core. An aluminum-alloy casting was formed in such a manner as to fill the cavities provided between the pair of cores and between the other core and the inner peripheral surface of the aluminum wrought material 51.

The cast portion 69 was formed by using a mold provided on the radially outer side of the aluminum wrought material 51. The cast portion 69 and the cast portion 57 were separately formed by supplying molten aluminum from a gate, which is not illustrated.

Now, a process of giving heat treatment to the aluminum structural member 280 configured as above will be described.

First, an aluminum alloy tube (an extrusion; material: A6063 (heat-treatable alloy); tempering: T5; outside diameter: φ60 mm; thickness: 2 mm) that is to become the aluminum wrought material 51 is set in a metal mold.

Aluminum alloy AC4C in a molten state is supplied to the outside and the inside of the aluminum alloy tube in such a manner as to have a thickness of 2 mm, and is cast at a casting temperature of 780° C. Thus, the aluminum structural member illustrated in FIGS. 23A and 23B is obtained.

Subsequently, the aluminum structural member that has been cast as above is heated to 520° C. and is retained at that temperature for five hours. Then, solution treatment is performed in which the aluminum structural member is forcibly cooled to room temperature by air cooling. Subsequently, aging treatment is performed at 160° C. for four hours.

Changes in the hardness of the aluminum structural member 280 thus heat-treated were measured. Table 1 summarizes Vickers hardness Hv (JIS Z 2 204) of the aluminum structural member 280 in each of different layered portions thereof, the hardness being measured immediately after aluminum casting and after the aging treatment.

TABLE 1

| | | | Vickers | Vickers |
|---|---|---|---|---|
| | | | hardness Hv | hardness Hv |
| | | | immediately | after solution |
| | | Measured | after aluminum | treatment and |
| Measured portion | | position | casting | aging treatment |
| Two-layer | Aluminum | OC1 | 58.1 | 86.0 |
| portion | casting | OC2 | 57.1 | 89.7 |
| | | OC3 | 58.4 | 90.2 |
| | Extrusion | EL1 | 44.5 | 89.3 |
| | | EL2 | 40.9 | 90.6 |
| | | EL3 | 35.6 | 68.5 |
| | | EL4 | 34.3 | 67.6 |
| | | EL5 | 34.7 | 69.4 |
| Three-layer | Aluminum | OCR1 | 53.5 | 92.4 |
| portion | casting | OCR2 | 55.0 | 93.3 |
| | (outer side) | OCR3 | 56.2 | 94.4 |
| | Extrusion | ER1 | 34.3 | 74.0 |
| | | ER2 | 34.1 | 86.8 |
| | | ER3 | 34.5 | 76.6 |
| | | ER4 | 35.3 | 72.1 |
| | | ER5 | 36.0 | 70.2 |
| | Aluminum | IC1 | 51.1 | 87.6 |
| | casting | IC2 | 49.8 | 85.5 |
| | (inner side) | IC3 | 51.0 | 88.4 |
| | | IC4 | 50.8 | 86.8 |
| | | IC5 | 50.4 | 84.0 |

Under the above insert-casting conditions, the aluminum wrought material 51 over which an aluminum-alloy casting is provided includes melt-solidified portions resulting from molten regions in the layered portions. The original Vickers hardness Hv of such an aluminum wrought material 51 of about 60 is reduced to about 35 to 40. When the insert-cast aluminum structural member 280 was subjected to solution treatment and then to aging treatment, the strength (hardness) recovered significantly. Specifically, if the aluminum wrought material 51 and the aluminum-alloy casting are each made of heat-treatable alloy, the hardness of each of the members increases and the hardness of the melt-solidified portions also increases. Consequently, the hardness of the structural member as a whole increases.

To summarize, the following are disclosed in this specification.

(1) An aluminum structural member including an aluminum wrought material made of aluminum or aluminum alloy, and an aluminum-alloy casting joined to the aluminum wrought material while being wrapped around the aluminum wrought material,

wherein the aluminum wrought material includes a portion serving as a joining portion protruding to the outside from the aluminum-alloy casting.

In this aluminum structural member, the portion of the aluminum wrought material that is wrapped with the aluminum-alloy casting is joined to the aluminum-alloy casting with high strength, and the two are integrally fixed to each other. A load applied to the aluminum wrought material at one end of the aluminum structural member can be borne by the aluminum-alloy casting at the other end of the aluminum structural member, and vice versa.

The aluminum wrought material has no voids (cavities) therein, unlike a cast material, and therefore has high dimensional accuracy and excellent wettability. Employing such an aluminum wrought material as a joining portion, the high dimensional accuracy of the wrought material can be utilized, and joining with high dimensional accuracy is realized even without machining that is to be performed in the case of casting.

The aluminum-alloy casting is formable into various shapes (such as a round shape, a rectangular shape, a tapered shape, a ribbed shape, and so forth). Since the aluminum-alloy casting is obtained by pouring molten metal into a mold, the aluminum-alloy casting has a higher design flexibility in the shape thereof than the aluminum wrought material.

The aluminum structural member includes the aluminum wrought material and the aluminum-alloy casting and is therefore lighter than a structural member made of iron or the like. The aluminum wrought material is wrapped with the aluminum-alloy casting. Therefore, even in an environment where water is present, the occurrence or progress of corrosion can be suppressed. Furthermore, the aluminum-alloy casting and the aluminum wrought material can be brought into close contact with each other by brazing, or a joining portion can be formed by melting at least a portion of the aluminum wrought material in the thickness direction. Therefore, higher joining strength is obtained.

As described above, the aluminum structural member according to the present configuration can exhibit the advantages of both the aluminum wrought material and the aluminum-alloy casting while the disadvantages of the two are compensated for with each other. Therefore, an excellent structural member is provided.

(2) The aluminum structural member according to (1), wherein at least one surface of the aluminum wrought material is exposed without being covered by the aluminum-alloy casting.

In such an aluminum structural member, since at least one surface of the aluminum wrought material is exposed without being covered by the aluminum-alloy casting, a joining-object member to be connected to the wrought material can be easily welded to the exposed portion in any of various kinds of arrangements or shapes of joints. Furthermore, since the dimensional accuracy of the aluminum wrought material itself can be utilized, the structural member can be assembled easily.

(3) The aluminum structural member according to (1) or (2), wherein the aluminum-alloy casting is provided with a plurality of aluminum wrought materials that are spaced apart from each other, with the aluminum-alloy casting being present between the spaced aluminum wrought materials.

In such an aluminum structural member, a plurality of aluminum wrought materials can be joined to each other with a cast portion. Furthermore, the plurality of aluminum wrought materials can be wrapped with the cast portion while being arbitrarily positioned relative to each other. Hence, the aluminum structural member can be used as a joint that joins joining-object members that are provided at arbitrary positions, respectively.

Furthermore, since the aluminum-alloy casting is present between the aluminum wrought materials, the area of the joining surface among the aluminum wrought materials and the aluminum-alloy casting in the cast portion is increased. Hence, in the aluminum structural member, the joining strength between the aluminum-alloy casting and each of the aluminum wrought materials and the rigidity thereof are improved, and the strength of the structural member as a whole is improved.

(4) The aluminum structural member according to any of (1) to (3), wherein the aluminum wrought material includes, in at least a region thereof, a melt-solidified portion that is formed by being fused with the aluminum-alloy casting.

In the aluminum structural member, since the melt-solidified portion is formed by the fusion between the aluminum wrought material and the aluminum-alloy casting, the joining strength between the two is further improved.

(5) The aluminum structural member according to (4), wherein the aluminum wrought material and the aluminum-alloy casting both have a Vickers hardness of 60 or higher.

In such an aluminum structural member, since the aluminum wrought material and the aluminum-alloy casting both have a Vickers hardness of 60 or higher, a very strong structure can be provided.

(6) The aluminum structural member according to (5), wherein at least one of the aluminum wrought material and the aluminum-alloy casting is made of heat-treatable alloy, and

wherein the melt-solidified portion of the aluminum wrought material has a hardness higher than the hardness of the aluminum wrought material that is yet to undergo insert casting.

In such an aluminum structural member, the melt-solidified portion of the aluminum wrought material resulting from the fusion with the aluminum-alloy casting and a softened portion of the aluminum wrought material each have a hardness higher than that of the wrought material that is yet to undergo insert casting. Therefore, the joining strength of the melt-solidified portion is increased, and the strength of the aluminum structural member as a whole is improved.

The present application claims the benefit of a Japanese patent application (Japanese Patent Application No. 2015-205847) filed Oct. 19, 2015 and a Japanese patent application (Japanese Patent Application No. 2016-145389) filed Jul. 25, 2016, the disclosures of which are hereby incorporated herein by reference.

### REFERENCE SIGNS LIST

11, 51, 53 aluminum wrought material
13 aluminum-alloy casting
17 joining portion
49 through hole
57 cast portion (supporting member)
69, 71 cast portion
100, 110, 120, 130, 140, 150, 160, 170, 180, 190, 200, 210, 220, 230, 240, 250, 260, 270, 280 aluminum structural member
C clearance

1. An aluminum structural member, comprising:
an aluminum wrought material made of aluminum or aluminum alloy; and
an aluminum-alloy casting joined to the aluminum wrought material while being wrapped around the aluminum wrought material,
wherein the aluminum wrought material comprises a portion serving as a joining portion protruding to an outside from the aluminum-alloy casting.

2. The aluminum structural member according to claim 1, wherein
at least one surface of the aluminum wrought material is exposed without being covered by the aluminum-alloy casting.

3. The aluminum structural member according to claim 1, wherein the aluminum-alloy casting is provided with a plurality of aluminum wrought materials that are spaced apart from each other, with the aluminum-alloy casting being present between the spaced aluminum wrought materials.

4. The aluminum structural member according to claim 2, wherein the aluminum-alloy casting is provided with a plurality of aluminum wrought materials that are spaced apart from each other, with the aluminum-alloy casting being present between the spaced aluminum wrought materials.

5. The aluminum structural member according to claim 1, wherein the aluminum wrought material comprises, in at least a region thereof, a melt-solidified portion that is formed by being fused with the aluminum-alloy casting.

6. The aluminum structural member according to claim 5, wherein the aluminum wrought material and the aluminum-alloy casting both have a Vickers hardness of 60 or higher.

7. The aluminum structural member according to claim 6, wherein:
at least one of the aluminum wrought material and the aluminum-alloy casting is made of heat-treatable alloy; and
the melt-solidified portion of the aluminum wrought material has a hardness higher than the hardness of the aluminum wrought material that is yet to undergo insert casting.
